(19) United States
(12) Patent Application Publication
(10) Pub. No.: US 2005/0246740 A1
(43) Pub. Date: Nov. 3, 2005

(54) Apparatus and method for evaluating media

(76) Inventors: Richard D. Teraci, Provo, UT (US); Sandra Sue Teraci, Provo, UT (US)

Correspondence Address: Mark F. Wright;Wright Law Group, PLLC, Suite 2, 7201 West Oakland, Chandler, AZ, 85226, US

(21) Appl. No.: 11/121,590

(22) Filed: May 3, 2005

Related U.S. Application Data
(60) Provisional application No. 60/568,110, filed on May 3, 2004.

(51) Int. Cl. H04N 7/173; G06F 13/00; H04N 5/445; G06F 3/00; H04H 9/00; H04N 7/16

(52) U.S. Cl. 725/45; 725/46; 725/134; 725/142

(57) ABSTRACT

The apparatus and methods of the present invention create an effective and efficient method for evaluating, rating, and categorizing media content intended for consumption by the general population. The present invention incorporates a plurality of media categories, category ratings, and category limits that, when taken together, provide information relative to media content for decision-making purposes. Each instance of media content is reviewed for instances of potentially objectionable material including violence, sensuality, language, ambiance, alcohol/drugs/smoking, and intensity. By scoring and weighting the various observed instances of the media content, an overall media “score” can be obtained. As desired, various weighting factors can be introduced and used to skew the final score of the media content. Finally, a label can be associated with the media content to identify and provide a visual indication of the media content score.

### RELATED APPLICATION

This application claims priority under 356 U.S.C. §119(e) to U.S. Provisional Patent Application Ser. No. 60/568,110, filed on May 3, 2004, which is hereby incorporated by reference in its entirety.

### FIELD OF THE INVENTION

The present invention relates generally to popular media and more specifically relates to evaluating, rating, and categorizing various types of media.

### BACKGROUND OF THE INVENTION

Consumers in today's competitive environment are bombarded with choices wherever they turn. Many styles, sizes, colors, etc. exist for almost any product that a consumer might wish to purchase. In fact, most consumers suffer from “information overload” and can sometimes postpone or forego a given purchase based on their inability to sort through all of their options and make a viable choice. In order to help the consumer make an informed purchasing decision, there are many readily available resources that may be deployed. These various resources include the recommendations of friends or experts, on-line research, user guides, and the like.

However, the mere presentation of information is not always enough to formalize an appropriate purchasing decision in the mind of the consumer. For example, a person may choose to frequent a popular fast-food restaurant, even though research has proven that a steady diet of fast food offerings may not be beneficial to long term health. Additionally, fast food restaurants are still opening on every corner and consumers continue to spend billions of dollars each year on food that they know is not necessarily very healthy for them. This example merely highlights the fact that the use of information is optional for each individual user. Consumers may choose to take advantage of the information available to them or they may choose to ignore the information available for a purchase decision. The consumer who chooses to absorb and evaluate the information available prior to making a purchasing decision typically benefits the most while those consumers that choose to ignore information may, in certain circumstances, be at a disadvantage.

One very common method of informing consumers during the purchasing cycle includes the use of various labels associated with the prospective purchase of certain goods and/or services. Labeling products is the American standard for assisting the consumer in making wise purchasing and consumption decisions. When shopping at the grocery store, a consumer may pick up a can of soup and read the contents. Based on the given facts and price, they can decide if it will provide required nutrients and sustained energy. The label may also provide medical information for a family member that may have an allergic reaction to a certain ingredient. Clothing labels provide percentage of fiber(s) contained. These labels can be used to assist the user in understanding about the characteristics of a given garment by evaluating such characteristics as “cleanability,” “wearability,” and “comfort.” All of these factors may guide purchasing decisions. Similarly, car shoppers look at the window sticker to know the standard equipment features, options, and price. A book or magazine has a table of contents that may label the contents and may also include additional informational items as well. Modern consumers are an integral part of our increasingly information-driven society and most consumers crave information related to the products and services that they plan to consume.

In general, the information provided on labels can help consumers gain the knowledge and understanding that ultimately lead to a purchasing decision, whether that decision is to purchase a product, purchase a competing product, or to make no purchase at all. Specifically, the consumer knowledge and understanding that is gained from reading a label may lead a consumer to a decision to not buy a specific product, but may also direct the consumer instead to the purchase of a product or service that is more suitable for their specific needs and/or wants. For example, a consumer may be looking at two types of candy bars, with the total number of calories displayed on the label for the candy bars. One of the candy bars is larger than the other. After reading the contents, the consumer may discover the larger candy bar actually has fewer calories because of new alternative sweetener. In this case, product labeling information may change the buying decision of the consumer at the point of sale.

However desirable, not all consumer consumption decisions are made in the context of adequate or even minimal amounts of information necessary for appropriate evaluation. In fact, certain market segments today are relatively bereft of the necessary information for making informed choice. One such area where adequate information is less than optimal is in the area of media consumption.

While the various presently known methodologies of information presentation and labeling are not without merit, most existing implementations for rating and categorizing popular media content have one or more significant drawbacks. For example, while a compact disc (CD) may have a label that warns the prospective purchaser about “explicit lyrics,” that may not be enough information to make a truly informed decision. Similarly, a “PG-13” movie rating, while providing some basic guidance, will rarely answer the questions a parent may have regarding the suitability of the content for their child. While many factors can affect the movie rating, it is impossible to tell from the rating alone whether the PG-13 rating due to violent content, sensuality, language, intensity, or some combination of the above. This can make the label applied to the movie practically worthless for many consumers. In frustration, the may reject the media content or, alternatively, be forced to undertake a concerted effort to locate additional material that will guide them in the decision-making process.

Given the present situation and, using the current technology, additional opportunities for the customized presentation of media content related information, along with the streamlined and controlled dissemination of information, are highly unlikely. Additionally, given the current limitations inherent in the existing methods of rating media content, even those users who have elected to become informed as to media-related choices are often unable to adequately access information and understand the limited information available to them in a timely and efficient fashion. Accordingly, without developing improved methods of simplifying the task of evaluating, rating, and categorizing media selections, the overall process of selecting and enjoying appropriate media content will continue to be sub-optimal.

### SUMMARY OF THE INVENTION

The apparatus and methods of the present invention create an effective and efficient method for evaluating, rating, and categorizing media content intended for consumption by the general population. The present invention incorporates a plurality of media categories, category ratings, and category limits that, when taken together, provide information relative to media content for decision-making purposes. Each instance of media content is reviewed for instances of potentially objectionable material including violence, sensuality, language, ambiance, alcohol/drugs/smoking, and intensity. By scoring and weighting the various observed instances of the media content, an overall media “score” can be obtained. As desired, various weighting factors can be introduced and used to “skew” the final score of the media content. Finally, a label can be associated with the media content to identify and provide a visual indication of the media content score.

### BRIEF DESCRIPTION OF THE DRAWINGS

The preferred embodiments of the present invention will hereinafter be described in conjunction with the appended wherein like designations denote like elements and:

FIG. 1 is a block diagram of a computer-based system for providing customized views of information and controlling access to information in accordance with a preferred embodiment of the present invention;

FIG. 2 is a block diagram of a data server from FIG. 1;

FIG. 3 is a flow chart of a method for evaluating and scoring media in accordance with a preferred embodiment of the present invention;

FIG. 4 is a schematic diagram of a media rating label in accordance with a preferred embodiment of the present invention;

FIG. 5 is a user interface for reviewing media content information in accordance with a preferred exemplary embodiment of the present invention:

FIG. 6 is a media content advisory label in accordance with a preferred exemplary embodiment of the present invention: and

FIG. 7 is a schematic representation of a plurality of media content advisory labels in accordance with a preferred embodiment of the present invention.

### DETAILED DESCRIPTION

The apparatus and methods of the present invention create an effective and efficient method for evaluating, rating, and categorizing media content intended for consumption by the general population. The present invention includes a plurality of media categories, category ratings, and category limits that, when taken together, provide information relative to media content for decision-making purposes.

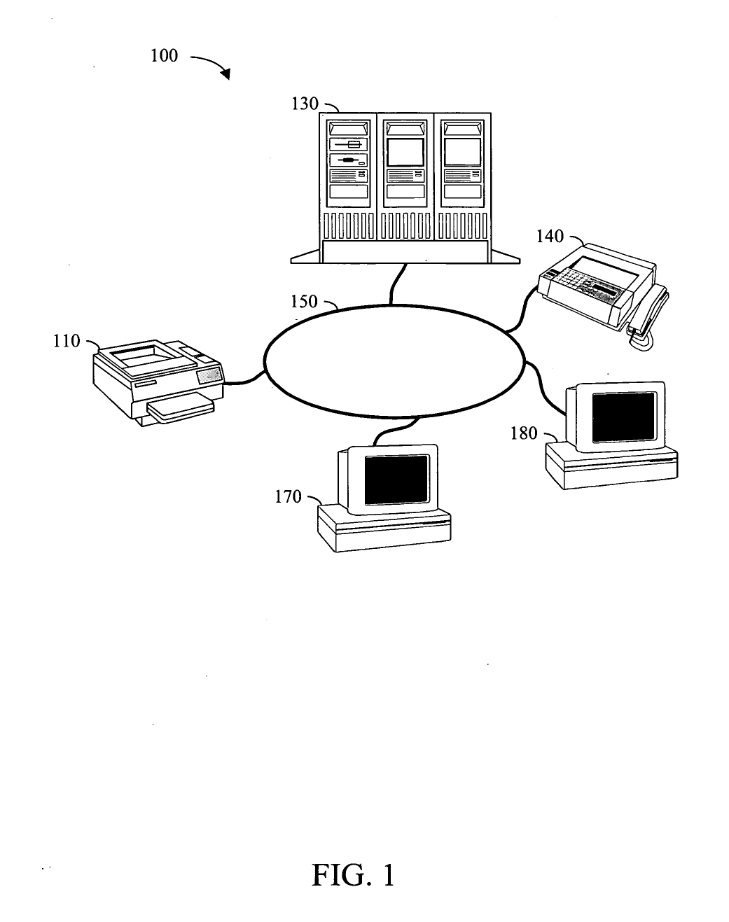

Referring now to FIG. 1, a block diagram of a computer-based system 100 for evaluating, rating, and categorizing media in accordance with a preferred embodiment of the present invention comprises: a data server 130; an information requesting computer system 170; and an information providing computer system 180, all connected or coupled via a network 120. Additionally, an optional printer 110 and an optional fax machine 140 are shown. Taken together, computer-based system 100 provides a way for individuals, organizations, families, and the like to more efficiently and effectively make media consumption choices, specifically related to popular media such as movies, music, books, etc., as described herein in conjunction with the various preferred embodiments of the present invention.

Data server 130 represents a relatively powerful computer system that is made available to information requesting computer system 170 and information providing computer system 180 via network 120. Various hardware components (not shown this FIG.) such as external monitors, keyboards, mice, tablets, secondary storage devices, hard disk drives, recordable CD-ROM/DVD drives and/or burners, jukeboxes, fax servers, magnetic tapes, and other devices known to those skilled in the art may be used in conjunction with data server 130. Data server 130 may also include various software components (not shown this FIG.) such as database servers, web servers, firewalls, security software, and the like. The use of these various hardware and software components is well known to those skilled in the art. Given the relative advances in the state-of-the-art computer systems available today, it is anticipated that the various functions of data server 130 may be provided by many standard, readily available data servers. Depending on the desired size and relative power required for data server 130, storage area network (SAN) technology may also be deployed in certain preferred embodiments of the present invention.

Information requesting computer system 170 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as an information requesting computer system 170. It should be noted that no specific operating system or hardware platform is excluded and it is anticipated that many different hardware and software platforms may be configured to create information requesting computer system 170. As previously explained in conjunction with data server 130; various hardware components and software components (not shown this FIG.) known to those skilled in the art may be used in conjunction with information requesting computer system 170. It should be noted that in many preferred embodiments of the present invention, information requesting computer system 170 is linked to its own LAN or WAN and has access to its own data server (not shown this FIG.).

Similarly, information providing computer system 180 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as an information providing computer system 180. It should be noted that no specific operating system or hardware platform is excluded and it is anticipated that many different hardware and software platforms may be configured to create information providing computer system 180. As previously explained in conjunction with data server 130, various hardware and software components (not shown this FIG.) known to those skilled in the art may be used in conjunction with information providing computer system 180. It should be noted that in many preferred embodiments of the present invention, information requesting computer system 180 is linked to its own LAN or WAN and has access to its own data server (not shown this FIG.).

Network 120 is any suitable computer communication link or communication mechanism, including a hardwired connection, an internal or external bus, a connection for telephone access via a modem or high-speed data line (T1, T3, etc.), radio, infrared or other wireless communications, public, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link. Different portions of network 120 may be configured and implemented using any or all of the various options described herein.

In the most preferred embodiments of the present invention, at least a portion of network 120 represents and comprises a standard Internet connection between the various components of computer-based system 100. Network 120 provides for communication between the various components of computer-based system 100 and allows for relevant information to be transmitted from device to device. In this fashion, users of computer-based system 100 can quickly and easily gain access to the relevant data and information as described in conjunction with the preferred embodiments of the present invention. Regardless of physical nature and topology, network 120 serves to logically link the physical components of computer-based system 100 together, regardless of their physical proximity. This is especially important because in many preferred embodiments of the present invention, data server 130, information requesting computer system 170, and information providing computer system 180 will be geographically remote and separated from each other.

In general, data server 130 stores information related to evaluating, categorizing and rating media content and processes requests for various transactions, including requests for the information stored on data server 130, by and, in certain preferred embodiments of the present invention, between information requesting computer system 170 and information providing computer system 180. A typical transaction may be represented by a request for access to certain media-related information made by one individual or entity relative to a specific media event, service, and/or product. In the most preferred embodiments of the present invention, the request will be made via a web-based application running on data server 130 and accessed by the user of information requesting computer 170 via any standard web browser, using the Internet. In this case, a request for access to certain information is sent from information requesting computer system 170 to data server 130. Data server 130 processed the request, formats the request for processing and returns a response to the inquiry. This request for access to information may be accomplished by any of the methodologies in presented in conjunction with the various preferred embodiments of the present invention described herein. Information providing computer system 180 may be used to input information into data server 130 for later access by users of system 100.

It should be noted that while FIG. 1 shows only a single information requesting computer system 170 and a single information providing computer system 180, it is anticipated that the most preferred embodiments of the present invention will comprise hundreds and even thousands of information requesting computer systems 170 and information providing computer systems 180, all connected via the Internet.

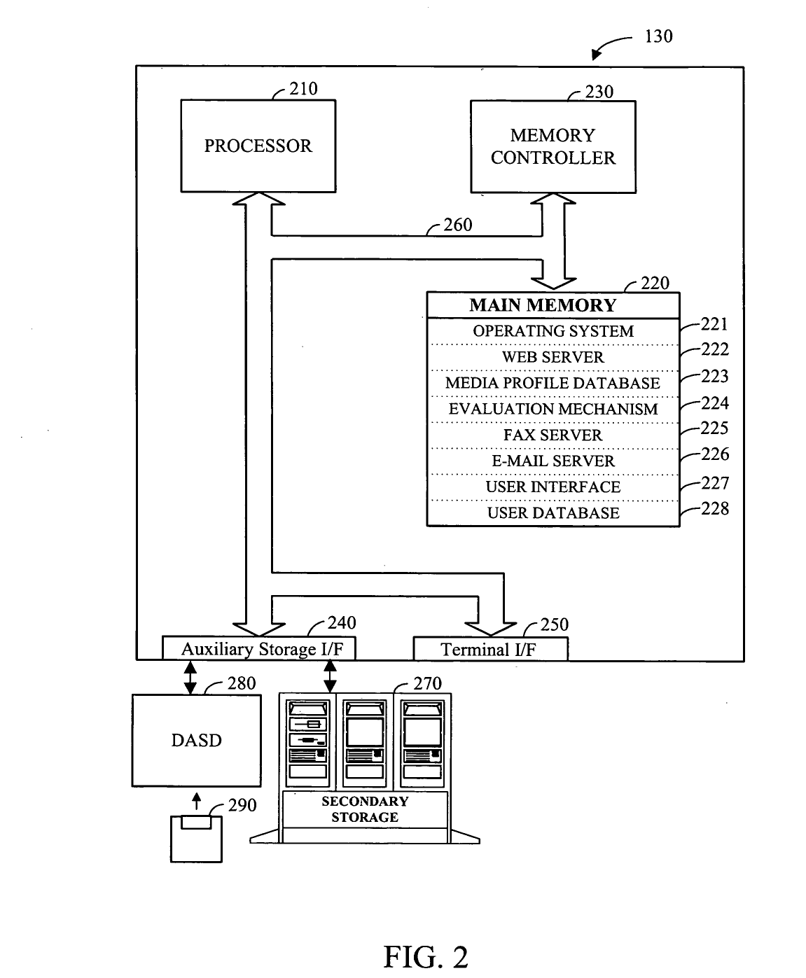

In the most preferred embodiments of the present invention, multiple information requesting computer systems 170 and multiple information providing computer systems 180 will all be configured to communicate with data server 130 and with each other via network 120. In addition, the most preferred embodiments of the present invention include an Application Service Provider (ASP) environment where data server 130 is operated as a clearinghouse in a hosted operation. In this fashion, multiple information requesting computer systems 170 and information providing computer systems 180 will have access to data server 130 on an as-needed basis. Data server 130 is further described below in conjunction with FIG. 2 below.

Optional printer 110 and an optional fax machine 140 are standard peripheral devices that may be used for transmitting or outputting paper-based documents, notes, transactions, reports, etc. in conjunction with the media-related queries and transactions processed by computer-based system 100. Optional printer 110 and an optional fax machine 140 may be directly connected to network 120 or indirectly connected via any or all of information requesting computer systems 170, information providing computer systems 180, and/or data server 130. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Referring now to FIG. 2, data server 130 in accordance with a preferred embodiment of the present invention is a most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface (I/F) 240, and a terminal interface (IF) 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the salient features of data server 130.

Processor 210 performs computation and control functions of data server 130, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a microprocessor. Processor 210 suitably executes one or more software programs contained within main memory 220.

Auxiliary storage interface 240 allows data server 130 to store and retrieve information from auxiliary storage devices, such as secondary storage device 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a floppy disk drive that may read programs and data from a floppy disk 290.

It is important to note that while the present invention has been (and will continue to be) described in the context of a fully functional computer system, those skilled in the art will appreciate that the mechanisms (particularly media profile database 223 and/or evaluation mechanism 224 and/or user interface 227 of FIG. 2) of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of suitable signal bearing media include: recordable type media such as floppy disks (e.g., disk 290) and CD ROMS, and transmission type media such as digital and analog communication links, including standard network connections and wireless communication links.

In the most preferred embodiments of the present invention, various preferred embodiments of the program product may be configured to communicate with the various entities involved in a typical information request and reply transaction, identify the participants in the transaction request, create and update media profile database 223, etc. In this fashion, the appropriate entities (i.e., individuals, families, media production companies, etc.) can utilize the program product to initiate and complete a wide variety of information-based transactions.

In the most preferred embodiments of the present invention, memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the functions provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as information requesting computer systems 170 and information providing computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be suitably employed.

Main memory 220 most preferably contains an operating system 221, a web server 222, media profile database 223, an evaluation mechanism 224, a fax server 225, an e-mail server 226, a user interface 227, and a user database 228. The term “memory” as used herein refers to any storage location in the virtual memory space of data server 130.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although evaluation mechanism 224 is shown to reside in the same memory location as operating system 221, it is to be understood that main memory 220 may consist of multiple disparate memory locations. It should also be noted that any and all of the individual components shown in main memory 220 may be combined in various forms and distributed as a stand-alone program product. Finally, it should be noted that additional components, not shown in this figure may also be included.

For example, most preferred embodiments of the present invention will include a security and/or encryption facility for verifying access to the data and information contained in and transmitted by data server 130. Additionally, the security mechanism may also provide encryption capabilities for computer-based system 100, thereby enhancing the robustness of computer-based system 100. Once again, depending on the type and quantity of information stored in media profile database 223, data server 130 may provide different levels of security and/or encryption for different computer systems 170 and 180. Additionally, the level and type of security measures applied by data server 130 may be determined by the nature of a given request and/or response. In some preferred embodiments of the present invention, media profile database 223 may contained in or implemented in conjunction with certain hardware components (not shown this FIG.) such as hardware-based firewalls, switches, dongles, and the like.

Operating system 221 typically includes the software that is used to operate and control data server 130. In general, processor 210 typically executes operating system 221. Operating system 221 may be a single program or, alternatively, a collection of multiple programs that act in concert to perform the functions of an operating system. Any operating system known to those skilled in the art may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single application, in certain preferred embodiments of the present invention web server 222 may be implemented as a cluster of multiple web servers. This configuration is generally recognized as providing additional robustness for system uptime and reliability purposes. Regardless of the specific form of implementation, Web server 222 provides system access, including a web browser-base user interface, to allow individuals and entities to interact with profile database 223 and Evaluation Mechanism 224, including via network 120 of FIG. 1.

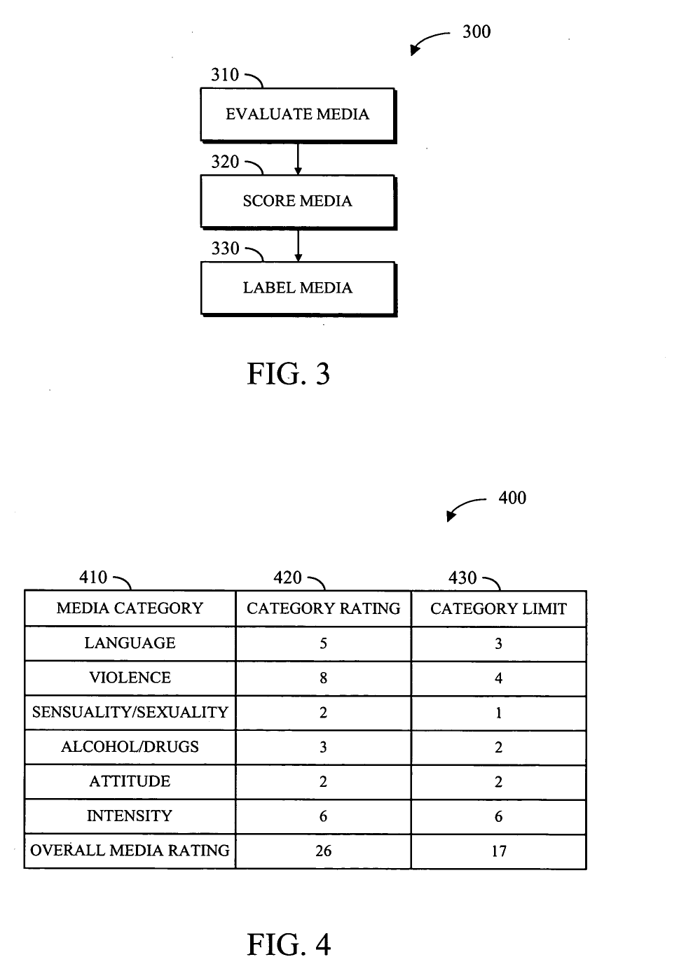

Media profile database 223 is used to store information related to various media events. This includes category ratings, numerical scores, commentary, and limits as described in conjunction with FIG. 3-FIG. 7. Additionally, information such as actors, plots, themes, production information, distribution information, etc. relative to various media events may also be included. Accordingly, it should be noted that media profile database 223 is representative of any database suitable for storing large quantities of information known to those skilled in the art. Media profile database 223 may be implemented using a standard Relational Database Management System (RDBS), a flat file structure, etc. In the most preferred embodiments of the present invention, media profile database 223 is a Structured Query Language (SQL) compatible database file capable of storing information relative to the media content to be evaluated and scored. While media profile database 223 is shown to be residing in main memory 220, it should be noted that media profile database 223 may be physically located in a location other than main memory 220. For example, media profile database 223 may be stored on secondary storage device 270 or DASD 280 and coupled to data server 130 via auxiliary storage I/F 240.

Evaluation mechanism 224 is any computer program suitable for creating, evaluating, rating, and/or maintaining and manipulating the information needed to fulfill the information request and respond to requests in accordance with the methodologies presented herein. Most preferably, evaluation mechanism 224 is a software application designed to receive, review, format and process requests for ratings relative to the various media events stored in media profile database 223. Additionally, evaluation mechanism 224 is configured to transmit and/or present the media event related information stored in media profile database 223 in a variety of formats, depending on the type of information requested and the type of access authorized in respond to a given request. While evaluation mechanism 224 is shown to be residing in main memory 220, it should be noted that evaluation mechanism 224 may be physically located in a location other than main memory 220. For example, evaluation mechanism 224 may be stored on external storage device 270 or DASD 280 and coupled to data server 130 via auxiliary storage I/F 240.

By extension, each and every parameter necessary to rate and/or evaluate any proposed media consumption may be found in media profile database 223 and interpreted by evaluation mechanism 224. The creation of various media profiles may also be stored in media profile database 223 and may be managed by the individuals or entities themselves via a standard web browser. The entities can use their web browser to access web server 222, thereby creating, updating and otherwise entering the relevant information for their respective profiles and for obtaining ratings for various media events.

It should be noted that media profile database 223 and/or evaluation mechanism 224 may be stored at a geographically remote location that is accessible via the Internet, by utilizing any suitable Internet file transfer application (XML, SOAP, etc.). In this type of distributed database environment, media profile database 223 may be implemented using various techniques known to those skilled in the art to prevent data redundancy and to ensure data integrity. Additionally, in the most preferred embodiments of the present invention, information for various file transfer protocols and specifications for communicating with computer systems 170 and 180 of FIG. 1 are also contained in media profile database 223.

While not required, the most preferred embodiments of data server 130 of FIG. 1 will typically include a fax server 225. Fax server 225 is any fax server known to those skilled in the art and is configured to receive inbound fax messages and to transmit outbound fax messages. Fax server 225 may format and transmit any fax-formatted data processed by any user of computer-based system 100 of FIG. 1 and make it available for use by any other component of computer-based system 100 of FIG. 1. Additionally, fax server 225 may process the data received and send it directly to evaluation mechanism 224 and make the incoming data available for further processing by computer-based system 100, including evaluation mechanism 224. Fax server 225 provides a mechanism for transmitting the media-related scores and other evaluation measure produced by computer-based system 100.

While not required, the most preferred embodiments of data server 130 of FIG. 2 will typically include an e-mail server 226. E-mail server 226 is any e-mail server application capable of being configured and used to send and receive various status messages and updates between computer systems 170 or 180 of FIG. 1 via e-mail, as may be necessary to enhance the overall process of information exchange as described herein. This includes the generation of automated e-mail messages relating to the preferred embodiments of the present invention related to requests and responses to requests for access to information, etc. E-mail server 226 provides a mechanism for transmitting the media-related scores and other evaluation measure produced by computer-based system 100.

User interface 227 is a web-based application that allows a user to access the various components of data server 130 via the Internet. For example, a user may choose to establish an account and store information relative to their media inquiries.

User database 228 is a database that stores information for the various users of system 100 of FIG. 1. This includes all necessary data relative to the various users and entities that access user database 228, including the names, addresses, account preferences, etc. for the users. It should be noted that user database 228 is representative of any database suitable for storing large quantities of information known to those skilled in the art. Media profile database 228 may be implemented using a standard Relational Database Management System (RDBS), a flat file structure, etc. In the most preferred embodiments of the present invention, media profile database 228 is a Structured Query Language (SQL) compatible database file

Referring now to FIG. 3, a flow chart for a method 300 of evaluating and scoring media content is depicted. As shown in FIG. 3, the basic steps of method 300 include evaluating the media (step 310), scoring the media content (step 320) and labeling the media (step 330). In the most preferred embodiments of the present invention, the step of evaluating the media will include the step of examining the media and identifying the desired content categories which will be used to score the media. This includes content categories such as violence, language, drugs/alcohol, sensuality, etc. Each selected content category will then be scored and given a base score, based on the prevalence or absence of the specified content in the selected media. The scoring can be accomplished in many different ways but the two most preferred methods involve relative scoring and normalized scoring.

Relative scoring provides a series of events or content in a given content category and then the content category for a given media title is rated relative to the baseline score. Thus, using a scale of 1-10, if a given media title has the same basic amount of violence as the baseline media title, it will receive a score of “5.” If a given media title has more or less violence than the baseline media title, then the score for that content category would be adjusted up or down accordingly.

In the normalized scoring method, all media titles are normalized against each other and the scores are calculated based on the pool of similar media types and titles. For example, all movies will be provided with a “raw score” based on the occurrence of certain events that are related to the selected media categories. Each act of drinking will be counted as will each act of drug use shown or depicted in a given media title. Then, the total number of events will be used as the score for that media content category for that media title. This score can then be normalized by comparing it with other media titles of the same genre (movies with movies, etc.). The media title with highest number of events in the selected media category will be the highest score on the scale (15, for example). Then, the media title with the lowest number of events in the selected media category will be given the lowest score on the scale (0, for example). All of the other media titles will then be proportionately scored relative to the highest and lowest score. This process will continue until all media content categories have been similarly scored.

As part of the step of scoring the media, certain preferred embodiments of the present invention will allow for the inclusion of user-selectable weighting criteria. In this instance, a user may decide to purposefully “skew” the rating scores for the various content categories by weighting one content category more than another. For example, if a user is more concerned about violence than language or sensuality, then the user may select a weighting factor of “2” for the violence content category and a weighting factor of “1” for the language and sensuality content categories. In this fashion, whatever base score is calculated for the violence content category will be multiplied by “2,” thereby significantly increasing the score for this content category. By carefully weighting the appropriate categories, the user can customize the ratings to match their specific needs for content scoring.

Finally, one or more labels can be physically or electronically applied to the various media titles to reflect the score for each media title. In the most preferred embodiments of the present invention, the label will be an indicia-bearing label with the indicia communicating a media content score for the associated media. The score will be indicative of the content and can be displayed as a total score or, more preferably, as a series of content category scores with each content category being scored individually and also including a total score calculated and based on the aggregate score of the content categories. In the most preferred embodiments of the present invention, evaluation mechanism 224 of FIG. 2 may be configured to print or otherwise display the indicia-bearing labels.

Referring now to FIG. 4, a sample media evaluation guide 400 is depicted. As shown in FIG. 4, media evaluation guide comprises a plurality of media categories (language, violence, sensuality/sexuality, alcohol/drugs, attire, intensity, etc.). It should be noted that the media categories depicted are representative only and fewer or more media categories may be included as desired. Each media category will typically include a category rating and a category limit. The category limits are a rating supplied by an independent rating board and the category limits are thresholds supplied by a prospective consumer of the media event represented by media evaluation guide 400.

A prospective consumer of the media event can choose their own threshold limits by entering the maximum allowable rating for each media category. Then, if a given media category rating exceeds the consumers pre-set limits, then the consumer can avoid exposure to the media event. Additionally, the consumer may use the total media rating category as another discriminating information factor for selecting media events for consumption. For example, a parent could set the category limits to control their child's access to one or more media events.

It is anticipated that various electronic devices (DVD players, etc.) may incorporate the media rating system described herein and allow or deny access to a given media event, based on both the individual category limits and the media rating provided by the various preferred embodiments of the present invention. Accordingly, a parent may program their DVD player to disallow the display of any media that exceeds any predetermined category level or that exceeds the total media rating. The DVD player may access a media profile database such as media profile database 223 of FIG. 2 via the Internet or a media profile database that is contained within the DVD player. Those skilled in the art will recognize that all types of media may be categorized as “media content,” including but not limited to, books, movies, music, plays, magazines, plays, radio station programs, television programs, newspapers, etc.

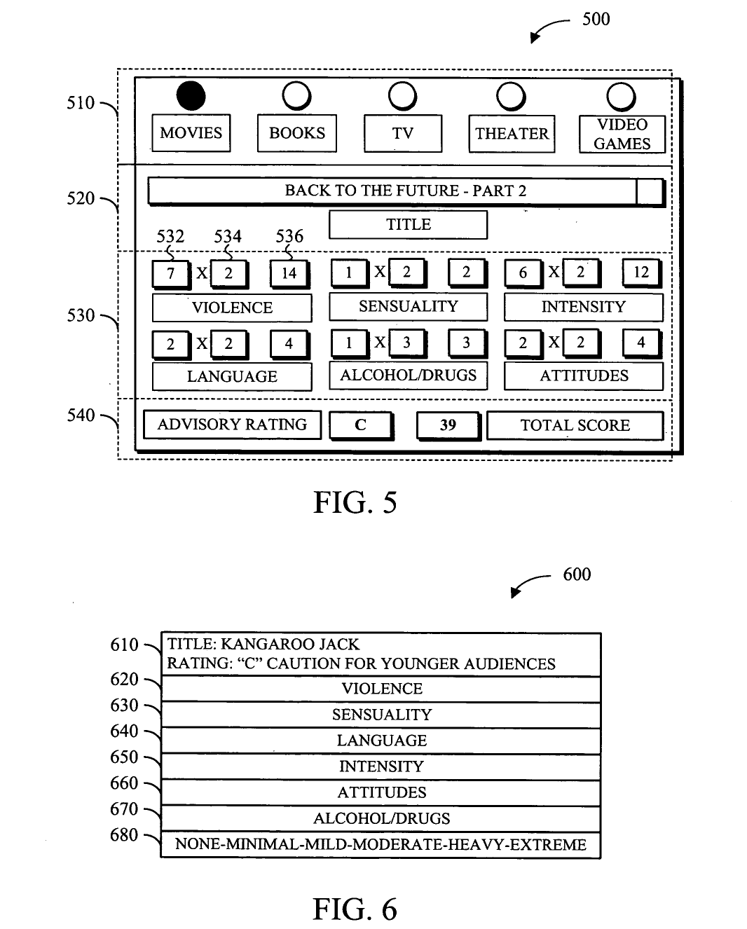

Referring now to FIG. 5, a user interface 500 in accordance with a preferred embodiment of the present invention is depicted. As shown in FIG. 5, user interface 500 includes a media type selection section 510. The possible media types that can be selected via user interface 500 are movies, books, TV, theater, and video games. These media types are illustrative only and those skilled in the art will recognize that other media types may also be included in user interface 500. The specific choices of media types to be included will be determined by user interface design factors and specific design choices, based upon the intended target audience.

Title section 520 of user interface 500 allows the user to scroll through an alphabetical listing of titles for the selected media type or to type a specific media title directly into user interface 520, much like a search engine. The titles and associated rating data for the various media types are contained in a database similar to media profile database 223 of FIG. 2. Once the desired media title has been located, the category ratings for the selected media title will be displayed in rating section 530. In this case, the media content categories include violence, sensuality, intensity, language, alcohol/drugs, and attitudes. The rating displayed for each content category is displayed numerically. For the violence content category, the displayed number is 7 as shown in content rating box 532. This is most preferably a relative rating, based on a scale of 1-10 or 1-15. In addition to the content category rating 532, a user-selectable weighting factor 534 may be included. The content category rating is multiplied by the weighting factor and the total rating or score 536 for the violence category is then calculated and displayed. Once the total rating or score has been calculated for each of the content categories, the total score and advisory rating may be displayed in scoring section 540. The inclusion of the weighting factors allows each user to customize user interface 500 and adapt the scoring system to their individual needs.

In the most preferred embodiments of the present invention, a potential media consumer will log into a website and access user interface 500. By selecting the appropriate media category 510, and applying their desired weighting factors, they will be able to receive a customized score for any desired media content. Scoring indicator section 540 depicts but one exemplary way of communicating the media content score to the potential media consumer.

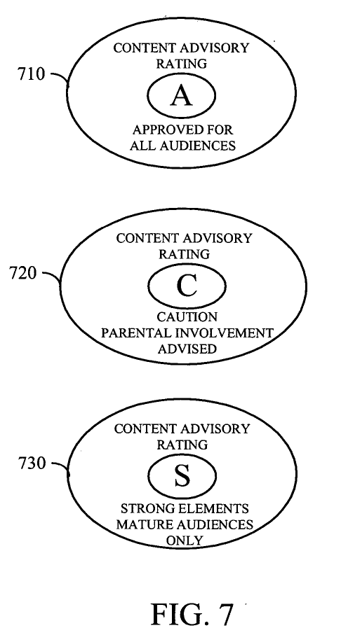

Based upon the exact scoring methodology adopted, the final score may be presented to the media consumer in a variety of ways. It is also anticipated that a label, incorporating a color scheme to highlight specific media-related information, and utilizing various scoring indicia, may be incorporated into the label for association with physical media content such as a book or DVD. Various such labels are shown in conjunction with FIG. 6 and FIG. 7.

Referring now to FIG. 6, a media-content advisory label 600 in accordance with a preferred embodiment of the present invention is shown. In this specific preferred embodiment, the title of the media 610 is listed at the top of label 600. Additionally, each of the relevant content categories 620-670 are also displayed directly on label 600. Finally, each content advisory category will have an associated color, based on the rating of the content for that content advisory category. For example, the “violence” content category 620 for this particular media title may be rated as “mild.” In that case, the word “violence” shown in content category 620 for this media title will be printed in the same color as the word “mild” shown at the bottom of the media content advisory label 600 in the rating category listing 680. This type of label may be applied to any type of suitable media content including books, CDs, DVDs, and the like. Additionally, it may be applied to movie posters, shown as an image on web pages advertising various types of media, and on television screens, etc.

Referring now to FIG. 7, a plurality of alternative media-content advisory labels in accordance with a preferred embodiment of the present invention is shown. As shown in FIG. 7, a family of one or more labels 710, 720, and 730 may be used to provide content advisory information for various types of media content by combining a single letter with a color. For example, label 710 provides a content advisory rating of “A” printed in the color green, which indicates the associated media is appropriate for all age groups. Label 720 provides a content advisory rating of “C,” with an associated color of yellow, indicating that parental involvement is advised. Label 730 provides a content advisory rating of “S” printed in a bright red color, meaning that the associated content is only advisable for consumption by mature audience.

In addition to the letter, the color can be useful for the efficient evaluation of media content at a glance. If further information is desired, then the potential media consumer can simply access the media content database on the Internet and determine which specific elements contributed to the media content advisory rating on the label. The use of two separate yet coordinating media content indicia on the labels allows for a quick and easy reference to the applicability of the media content for various age groups and levels of maturity for the intended audience. This type of label may be applied to any type of suitable media content including books, CDs, DVDs, and the like. Additionally, it may be applied to movie posters, and shown on web pages advertising various types of media. Those skilled in the art will recognize that other similar types of rating may be developed. For example, the letters and associated colors may be modified without deviating from the invention in any significant way.

Additionally, the software portions of the various preferred embodiments of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of suitable signal bearing media include: recordable type media such as floppy disks and CD ROMS, and transmission type media such as digital and analog communication links, including standard network connections and wireless communication links.

In summary, the present invention provides for the broad application of a unique process for evaluating and scoring media content and providing customized views of the related information via computer networks such as the Internet. While the various preferred embodiments of the present invention have been described in conjunction with specific examples of media, those skilled in the art will appreciate that the apparatus and methods of the present invention are suitable for deployment in other areas as well.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An apparatus comprising:
at least one processor;
a memory coupled to said at least one processor;
a media profile database residing in said memory, said media profile database containing a plurality of content categories related to at least one media title; and
an evaluation mechanism residing in said memory, said evaluation mechanism providing a content category score for each of said content categories, said evaluation mechanism providing a total score for said at least one media title based upon said plurality of content categories.

2. The apparatus of claim 1 further comprising a weighting factor residing in said memory, said weighting factor providing an adjusted score for said content category score for each of said content categories.

3. The apparatus of claim 1 further comprising a user database residing in said memory, said user database comprising a plurality of data records, said plurality of data records comprising data related to a plurality of users of said apparatus.

4. The apparatus of claim 1 further comprising a user interface residing in said memory, said user interface providing a mechanism for introducing a weighting factor, said weighting factor providing an adjusted score for said content category score for each of said content categories.

5. The apparatus of claim 1 further comprising:
a user database residing in said memory, said user database comprising a plurality of data records, said plurality of data records comprising data related to a plurality of users of said apparatus;
a user interface residing in said memory, said user interface providing a mechanism for introducing a weighting factor, said weighting factor providing an adjusted score for said content category score for each of said content categories;
a fax server residing in said memory, said fax server providing a mechanism for transmitting said total score; and
an e-mail server residing in said memory, said e-mail server providing a mechanism for transmitting said total score.

6. The apparatus of claim 1 further comprising an indicia-bearing label affixed to a media title, said label bearing said total score.

7. The apparatus of claim 1 further comprising:
a user database residing in said memory, said user database comprising a plurality of data records, said plurality of data records comprising data related to a plurality of users of said apparatus; and
a user interface residing in said memory, said user interface providing a mechanism for introducing a weighting factor, said weighting factor providing an adjusted score for said content category score for each of said content categories.

8. The apparatus of claim 6 wherein said total score comprises both a color and a number.

9. A method comprising the steps of:
identifying a plurality of content categories for media content;
evaluating said media event; and
assigning at least one score for each of said plurality of media categories; and
calculating a total score based on said at least one score for each of said plurality of media categories.

10. The method of claim 9 wherein said step of assigning a score for each of said plurality of content categories comprises the steps of:
accessing a media profile database and extracting a numerical value representing said score for said plurality of content categories; and
adjusting said numerical value representing said score for said plurality of content categories by a user-selectable weighting factor.

11. The method of claim 10 further comprising the step of affixing an indicia-bearing label affixed to a media title, said indicia-bearing label bearing said total score.

12. The apparatus of claim 11 wherein said total score comprises both a color and a number.

13. A program product comprising:
an evaluation mechanism, said evaluation mechanism providing a content category score for a plurality of content categories, said evaluation mechanism providing a total score for at least one media title based upon said plurality of content categories; and
signal bearing media bearing said evaluation mechanism.

14. The program product of claim 13 further comprising a media profile database, said media profile database being configured to contain said plurality of content categories related to said at least one media title.

15. The program product of claim 13 wherein said signal bearing media comprises recordable media.

16. The program product of claim 13 wherein said signal bearing media comprises transmission media.

17. The program product of claim 13 further comprising a user interface, said user interface being configured to provide a user-selectable weighting factor to adjust said content category scores for said plurality of content categories, thereby adjusting said total score for said at least one media title.

18. The program product of claim 13 further comprising:
a media profile database, said media profile database being configured to contain said plurality of content categories related to said at least one media title;
a user interface, said user interface being configured to provide a user-selectable weighting factor to adjust said content category scores for said plurality of content categories, thereby adjusting said total score for said at least one media title;
a fax server, said fax server being configured to provide a mechanism for transmitting said total score; and
an e-mail server, said e-mail server being configured to provide a mechanism for transmitting said total score.

19. The program product of claim 13 wherein said evaluation mechanism is configured to print an indicia-bearing label, said indicia-bearing label bearing said total score.

20. The apparatus of claim 19 wherein said total score comprises both a color and a number.
